(19) United States
(12) Patent Application Publication
(10) Pub. No.: US 2018/0072933 A1
(43) Pub. Date: Mar. 15, 2018

(54) HEAT DISSIPATION COATING LAYER AND MANUFACTURING METHOD THEREOF

(71) Applicant: BGT MATERIALS LIMITED, MANCHESTER (GB)

(72) Inventors: CHUNG-PING LAI, ZHUBEI CITY (TW); KUO-HSIN CHANG, DALIN TOWNSHIP (TW); JIA-CING CHEN, TAINAN CITY (TW); WE-JEI KE, XINFENG TOWNSHIP (TW)

(21) Appl. No.: 15/263,368

(22) Filed: Sep. 13, 2016

(51) Int. Cl. C09K 5/14; C09D 7/12; C09D 7/14; C09D 183/04; C09D 133/10; C09D 175/04; C09D 163/00

(52) U.S. Cl. CPC C09K 5/14; C09D 7/1216; C09D 7/1283; C09D 7/14; C08K 9/10; C09D 133/10; C09D 175/04; C09D 163/00; C09D 183/04

(57) ABSTRACT

A heat dissipation coating layer contains: a heat dissipation filler and a binder which are synthesized in a water bathing manner. The heat dissipation filler includes a metal core formed on a central portion of the heat dissipation filler, and the heat dissipation filler also includes a metal shell surrounding the metal core, wherein the metal core has metal particles, and the metal shell has porous metal oxide particles and porous metal hydroxide particles, a size of each of the porous metal oxide particles and the porous metal hydroxide particles is less than 500 nm.

### FIELD OF THE INVENTION

The present invention relates to a heat dissipation coating layer which contains heat dissipation filler including a metal core and a metal shell, wherein the metal core has metal particles, and the metal shell has porous metal oxide particles and porous metal hydroxide particles.

### BACKGROUND OF THE INVENTION

A conventional thermally conductive composition is disclosed in US Publication No. 20070249755 A1. A heat dissipation material and a method of manufacturing thereof are disclosed in CN 102181212A. The thermally conductive composition and the heat dissipation material dissipates heat in a conduction manner or in a convention manner, and far-infrared emission rate of the heat dissipation material is more than 0.80 or a thermal conductivity is more than 5 W/m·K.

A metal foam heat dissipator is disclosed in EP0559092 A1 and contains a metal frame adhered on the heat dissipator made of metal, however, a heat contact surface is small and a large thermal contact resistance exists between the heat dissipator and the metal frame.

A porous metal heat dissipator is taught in CN 102368482A, but is cannot connect the metal frame with the heat dissipator integrally.

A hydrothermal method or acid-etching method is disclosed in [ChemCatChem, 6(2014) 2642], [Cent. Eur. J. Phys, 8(2010) 1015] and is applied to form porous Al2o3 core and a porous Al2o3 shell. However, such a method will cause poor thermal conductivity and toxic solvents to pollute environment.

The present invention has arisen to mitigate and/or obviate the afore-described disadvantages.

### SUMMARY OF THE INVENTION

The primary objective of the present invention is to provide a heat dissipation coating layer which contains heat dissipation filler including a metal core and a metal shell, wherein the metal core has metal particles, and the metal shell has porous metal oxide particles and porous metal hydroxide particles, thus enhancing a heat dissipation rate or a cooling rate of the heat dissipation coating layer.

To obtain above-mentioned objective, a heat dissipation coating layer provided by the present invention contains: heat dissipation filler and a binder which are synthesized in a water bathing manner.

The heat dissipation filler includes a metal core formed on a central portion of the heat dissipation filler, and the heat dissipation filler also includes a metal shell surrounding the metal core, wherein the metal core has metal particles, and the metal shell has porous metal oxide particles and porous metal hydroxide particles, a size of each of the porous metal oxide particles and the porous metal hydroxide particles is less than 500 nm.

Preferably, a size of each of the metal particles of the metal core is within 0.1 μm to 200 μm.

Preferably, the metal core is any one of Al, In, Sn, Zn, Cu, Ag, Co, Ni, Sb, Bi, Fe, Mn, Cr, Mo, W, V, Ti, Zr, Mg, and Ca.

Preferably, the heat dissipation coating layer further contains any one of ceramics filler, metal oxide filler, and hydroxide filler.

Preferably, the binder is any one of thermoplastic resin, silicone resin, methacrylic resin, urethane resin, and epoxy resin.

Preferably, the metal shell is any one of metal oxides, ceramics, and metal hydroxides.

Preferably, a reaction temperature of the water bathing manner is within 20° C. to 100° C.

Preferably, a reaction temperature of the water bathing manner is within 50° C. to 100° C.

A method of manufacturing the heat dissipation coating layer comprising steps of:

Synthesizing a metal core and a metal shell in a water bathing manner, wherein the metal core has metal particles, and the metal shell has porous metal oxide particles and porous metal hydroxide particles, hence the metal core and the metal shell form the heat dissipation filler; and

Mixing the heat dissipation filler and the binder evenly so as to produce the heat dissipation coating layer.

The method further contains steps of: washing the heat dissipation filler by using water; and drying the heat dissipation filler.

The method further contains step of: mixing the heat dissipation coating layer and solvent together.

### BRIEF DESCRIPTION OF THE DRAWINGS

FIG. 1 is schematic view showing a heat dissipation coating layer according to a preferred embodiment of the present invention.

FIG. 2 is an amplified schematic view of a part of FIG. 1.

FIG. 3 is a schematic view showing the application of the heat dissipation coating layer according to the preferred embodiment of the present invention.

FIG. 4 is a schematic view showing testing result of sample 1, sample 2 and sample 3 of the heat dissipation coating layer according to the preferred embodiment of the present invention.

FIG. 5 shows an image of the sample 3 scanned by a scanning electron microscope (SEM).

FIG. 6 shows an image of the sample 2 scanned by the scanning electron microscope (SEM).

### DETAILED DESCRIPTION OF THE PREFERRED EMBODIMENTS

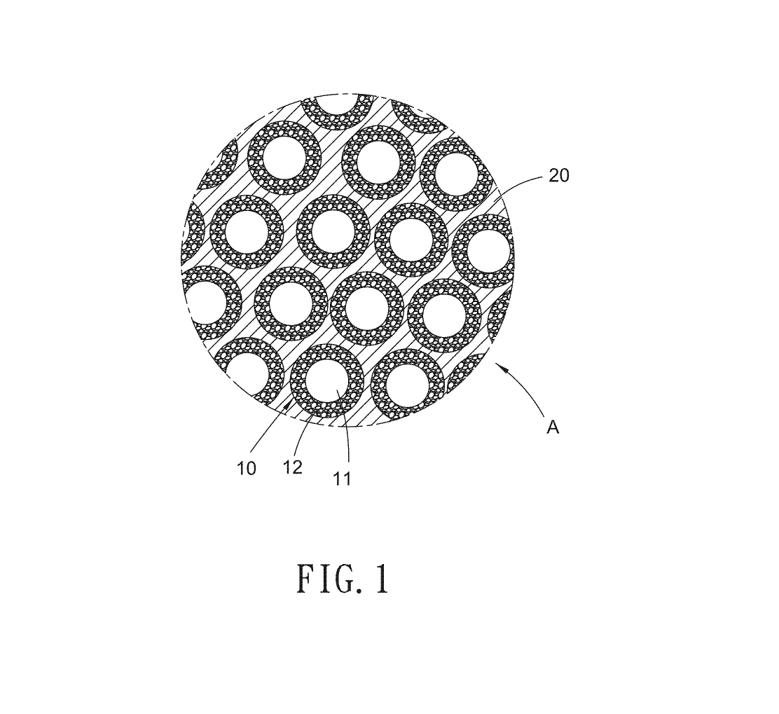

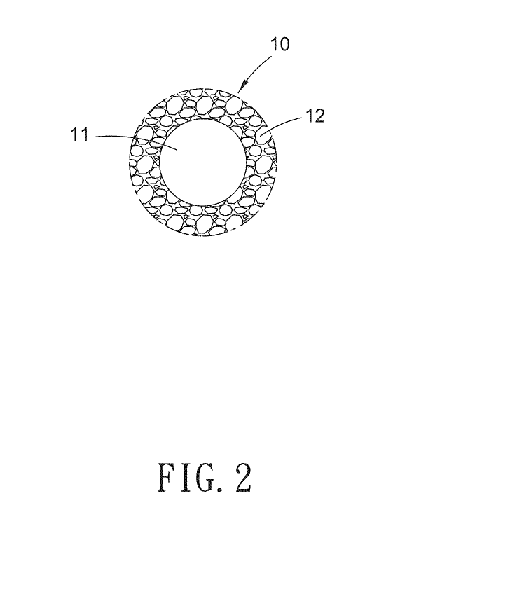

With reference to FIGS. 1-6, a heat dissipation coating layer according to a preferred embodiment of the present invention comprises: a heat dissipation filler 10 and a binder 20, wherein the heat dissipation filler 10 includes a metal core 11 formed on a central portion thereof, the heat dissipation filler 10 also includes a metal shell 12 surrounding the metal core 11, wherein the metal core 11 has metal particles, and the metal shell 12 has porous metal oxide particles and porous metal hydroxide particles.

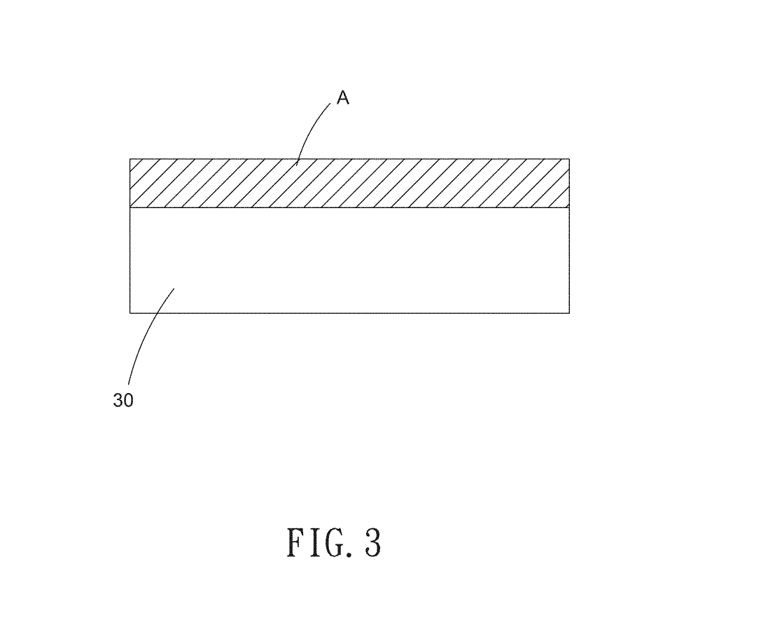

Referring to FIG. 3, the heat dissipation coating layer A is coated on an apparatus 30, wherein the heat dissipation filler 10 includes the metal core 11 and the metal shell 12, and the metal shell 12 has the porous metal oxide particles and the porous metal hydroxide particles. The metal shell 12 is synthesized in a water bathing manner and is any one of metal oxides, ceramics, and metal hydroxides, hence the metal shell 12 enhances a heat dissipation rate or a cooling rate of the apparatus 30 in a conduction manner or in a convention manner.

The heat dissipation coating layer A is applicable for the apparatus 30, such as a filament, a grip, a column, a heat sink, and a case, wherein the apparatus 30 is made of any one or any combination of any two or more of plastic, ceramic, and metal.

A size of each of the metal particles of the metal core 11 is within 0.1 μm to 200 μm, and a size of each of the porous metal oxide particles and the porous metal hydroxide particles is less than 500 nm.

The metal core 11 is any one of Al, In, Sn, Zn, Cu, Ag, Co, Ni, Sb, Bi, Fe, Mn, Cr, Mo, W, V, Ti, Zr, Mg, and Ca.

In one embodiment, the metal core 11 is Al.

The binder 20 is any one of thermoplastic resin, silicone resin, methacrylic resin, urethane resin, and epoxy resin.

The heat dissipation coating layer of the present invention further comprises any one of ceramics filler, metal oxide filler, and hydroxide filler.

To enhance an area of the heat dissipation filler 10 of the heat dissipation coating layer, a method of manufacturing the heat dissipation coating layer A comprises steps of:

Synthesizing the metal core 11 and the metal shell 12 in the water bathing manner, wherein the metal core 11 has the metal particles, and the metal shell 12 has the porous metal oxide particles and the porous metal hydroxide particles, hence the metal core 11 and the metal shell 12 form the heat dissipation filler 10; and

Mixing the heat dissipation filler 10 and the binder 20 evenly so as to produce the heat dissipation coating layer A.

A reaction temperature of the water bathing manner is within 20° C. to 100° C. Preferably, the reaction temperature of the water bathing manner is within 50° C. to 100° C.

The method of manufacturing the heat dissipation filler 10 comprises steps of:

Washing the heat dissipation filler 10 by using water; and

Drying the heat dissipation filler 10.

In one embodiment, the method of manufacturing the heat dissipation filler 10 further comprises step of:

Mixing the heat dissipation coating layer and solvent together, wherein the solvent is any one of isopropyl alcohol (IPA), methyl-2-pyrrolidone (NMP), ethanol, glycerol, ethylene glycol, butanol, propylene glycol monomethyl ether (PGME), and propylene glycol monomethyl ether acetate (PGMEA).

To evaluate heat dissipation rate of the heat dissipation coating layer A of the present invention, three samples made of copper column are provided and they are:

sample 1 on which the heat dissipation coating layer is not coated;

sample 2 on which the heat dissipation coating layer is coated, and the heat dissipation coating layer includes the heat dissipation filler made of raw aluminum particles; and

sample 3 on which the heat dissipation coating layer is coated, wherein the sample 3 is made of the copper column, and the heat dissipation coating layer includes the heat dissipation filler made of raw aluminum particles.

A method of manufacturing the heat dissipation coating layer on the sample 2 contains steps of:

Providing and drying aluminum powders of 30 g in a temperature of 140° C. in a vacuum oven for 8 hours, wherein a size of each of the aluminum powders is 10 μm, and an image of the aluminum powders scanned by a scanning electron microscope (SEM) is shown in FIG. 6, wherein the heat dissipation coating layer produces after drying the aluminum powders, and the heat dissipation coating layer consists of 18.70 wt % of the aluminum powders, 5.80 wt % of binder, and 75.50 wt % of isopropyl alcohol (IPA) used as solvent so as to reduce stickiness of the heat dissipation coating layer;

Mixing the aluminum powders, the binder, and the isopropyl alcohol (IPA) together by using a planetary mixer for 1 hour; and

Spraying the heat dissipation coating layer on a cooper column so as to test the heat dissipation rate of the heat dissipation coating layer on the sample 2.

A method of manufacturing the heat dissipation coating layer on the sample 3 contains steps of:

Providing and placing aluminum powders of 30 g in a beaker of 500 ml, wherein a size of each of the aluminum powders is 10 μm;

Adding deionized water of 300 g into the beaker and synthesizing the metal core and the metal shell in a water bathing manner in a temperature of 323K for 1 hour, wherein the metal core has aluminum particles, and the metal shell has porous aluminum oxide particles and porous aluminum hydroxide particles, thus producing the heat dissipation filler of the present invention;

Washing the heat dissipation filler 10 by using water;

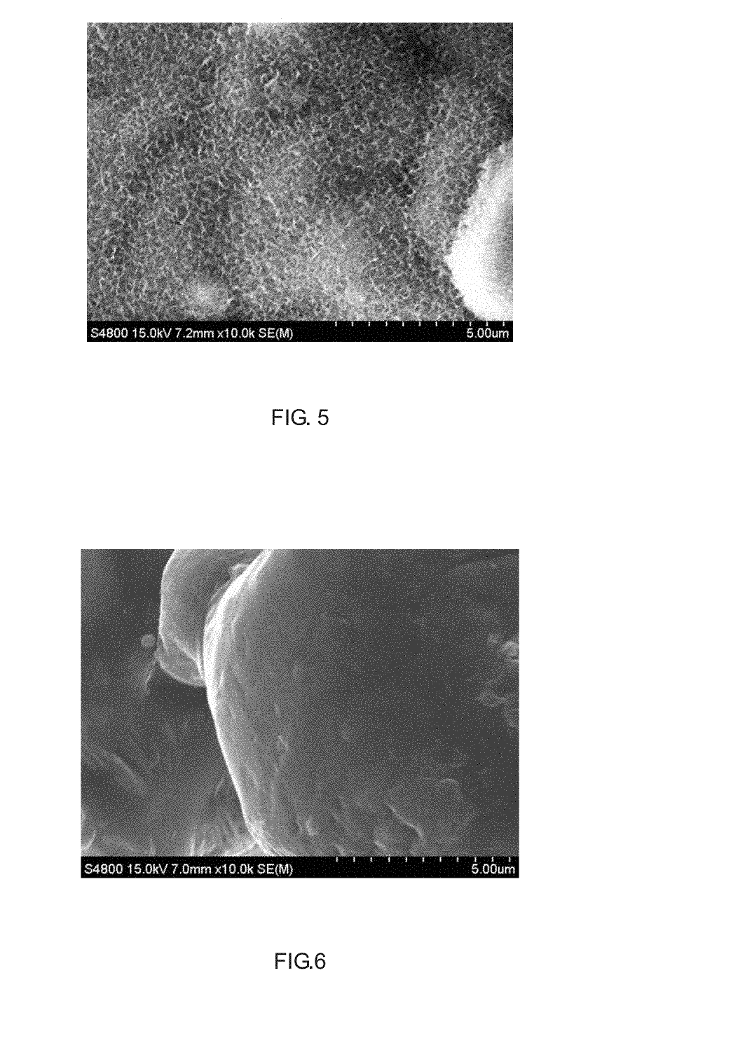

Drying the heat dissipation filler in in a temperature of 140° C. in a vacuum oven for 8 hours, wherein an image of the heat dissipation filler 10 scanned by the scanning electron microscope (SEM) is shown in FIG. 5, and the heat dissipation coating layer produces after being dried, wherein the heat dissipation coating layer consists of 18.70 wt % of the aluminum powders, 5.80 wt % of binder, and 75.50 wt % of isopropyl alcohol (IPA) used as solvent so as to reduce stickiness of the heat dissipation coating layer;

Mixing the aluminum powders, the binder, and the isopropyl alcohol (IPA) by using a planetary mixer for 1 hour; and

Spraying the heat dissipation coating layer on the cooper column so as to test heat dissipation rate of the heat dissipation coating layer on the sample 3.

Preferably, the sample 1, the sample 2, and the sample 3 are tested according to steps of:

(1) Placing the sample 1, the sample 2, and the sample 3 in an oven and heating the sample 1, the sample 2, and the sample 3 in a temperature of 100° C. for 30 minutes; and

(2) Removing the sample 1, the sample 2, and the sample 3 out of the oven and cooling the sample 1, the sample 2, and the sample 3 in a room temperature.

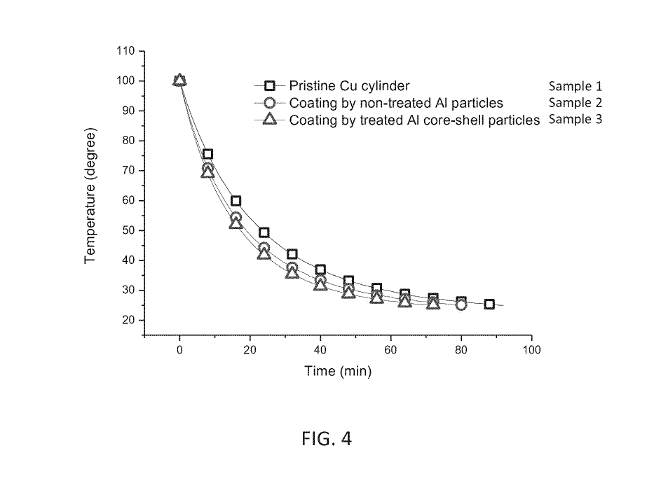

Thereafter, cooling curves of the sample 1, the sample 2, and the sample 3 are illustrated in FIG. 4.

Thereby, a heat dissipation rate of the sample 3, denoted by Coating by treated Al core-shell particles of FIG. 4, is more brilliant than sample 1 (designed by Pristine Cu Cylinder) of FIG. 4) and the sample 2 (presented by Coating by non-treated Al particles of FIG. 4).

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A heat dissipation coating layer comprising: a heat dissipation filler and a binder which are synthesized in a water bathing manner;
wherein the heat dissipation filler includes a metal core formed on a central portion of the heat dissipation filler, and the heat dissipation filler also includes a metal shell surrounding the metal core, wherein the metal core has metal particles, and the metal shell has porous metal oxide particles and porous metal hydroxide particles, a size of each of the porous metal oxide particles and the porous metal hydroxide particles is less than 500 nm.

2. The heat dissipation coating layer as claimed in claim 1, wherein a size of each of the metal particles of the metal core is within 0.1 μm to 200 μm.

3. The heat dissipation coating layer as claimed in claim 1, wherein the metal core is any one of Al, In, Sn, Zn, Cu, Ag, Co, Ni, Sb, Bi, Fe, Mn, Cr, Mo, W, V, Ti, Zr, Mg, and Ca.

4. The heat dissipation coating layer as claimed in claim 1 further comprising any one of ceramics filler, metal oxide filler, and hydroxide filler.

5. The heat dissipation coating layer as claimed in claim 1, wherein the binder is any one of thermoplastic resin, silicone resin, methacrylic resin, urethane resin, and epoxy resin.

6. The heat dissipation coating layer as claimed in claim 1, wherein the metal shell is any one of metal oxides, ceramics, and metal hydroxides.

7. The heat dissipation coating layer as claimed in claim 1, wherein a reaction temperature of the water bathing manner is within 20° C. to 100° C.

8. The heat dissipation coating layer as claimed in claim 1, wherein a reaction temperature of the water bathing manner is within 50° C. to 100° C.

9. A method of manufacturing heat dissipation coating layer comprising steps of:
Synthesizing a metal core and a metal shell in a water bathing manner, wherein the metal core has metal particles, and the metal shell has porous metal oxide particles and porous metal hydroxide particles, hence the metal core and the metal shell form the heat dissipation filler; and
Mixing the heat dissipation filler and the binder evenly so as to produce the heat dissipation coating layer.

10. The method as claimed in claim 9, wherein a size of each of the metal particles of the metal core is within 0.1 μm to 200 μm.

11. The method as claimed in claim 9, wherein the metal core is any one of Al, In, Sn, Zn, Cu, Ag, Co, Ni, Sb, Bi, Fe, Mn, Cr, Mo, W, V, Ti, Zr, Mg, and Ca.

12. The method as claimed in claim 9, wherein the binder is any one of thermoplastic resin, silicone resin, methacrylic resin, urethane resin, and epoxy resin.

13. The method as claimed in claim 9, wherein a reaction temperature of the water bathing manner is within 20° C. to 100° C.

14. The method as claimed in claim 9, wherein a reaction temperature of the water bathing manner is within 50° C. to 100° C.

15. The method as claimed in claim 9 further comprising steps of: washing the heat dissipation filler by using water; and drying the heat dissipation filler.

16. The method as claimed in claim 9 further comprising step of: mixing the heat dissipation coating layer and solvent together.
